(19) United States
(12) Patent Application Publication
(10) Pub. No.: US 2002/0111901 A1
(43) Pub. Date: Aug. 15, 2002

(54) Loan servicing system

(76) Inventor: Patrick G. Whitney, Dallas, TX (US)

Correspondence Address: William D. McSpadden, BAKER & McKENZIE, Suite 2300, 2001 Ross Avenue, Dallas, TX, 75201, US

(21) Appl. No.: 10/056,795

(22) Filed: Jan. 24, 2002

Related U.S. Application Data
(60) Provisional application No. 60/263,925, filed on Jan. 24, 2001.

(51) Int. Cl. G06F 17/60

(52) U.S. Cl. 705/38

(57) ABSTRACT

A system and method for facilitating the financing of a transaction between a vendor and a customer for goods and/or services. Prior to the commencement of the transaction between the vendor and the customer, the customer executes a note that is payable to a lending institution such that the customer will be obliged to pay the lending institution after the vendor provides the purchased goods and/or services. As the customer makes payments to the lending institution, the lending institution retains an interest portion of the payment and the vendor is paid a principal portion of the payment. In another embodiment, a loan servicing company may act to facilitate the transaction between the vendor, the lending institution and the customer such that all necessary paperwork and applications may be centrally controlled. In yet another embodiment, this system and method may be implemented electronically so that the financing of the transaction may occur electronically without the generation of excessive paperwork. Yet another aspect of the invention contemplates that a loan servicing company will maintain electronic databases that contain information about qualified vendors, customers and lending institutions so as to facilitate financing of transactions.

### CROSS REFERENCE TO RELATED APPLICATIONS

This application claims priority to provisional patent application No. 60/263,925 entitled “Loan Servicing System,” which has a filing date of Jan. 24, 2001.

### BACKGROUND

This disclosure relates to unsecured financing of account receivables by vendors, such as merchants or service providers, and more particularly, to the origination and servicing of the underlying installment loan contracts, which support this financing activity.

Loans and credit allow customers access to services and products, which the customer is unable to pay for at the time the service is rendered or product purchased. Instead of paying immediately the full price for the service or product, loans and credit allow the customer to pay portions of the price over a period of time. The foregoing allows the customer to arrange future financial budgets and planning to accommodate the regular payment obligation. From service provider's point of view, a loan or extension of credit increases the sales volume. For the convenience provided, the lender or creditor receives loan servicing fees as well as interest on the tendered loan.

However, failure on the part of the customer to repay the loan, known as defaulting, is a significant risk associated with lending and the extension of credit. Lenders and creditors establish risk-based loan servicing fees and rates of interest in accordance with the assessed risk of default for loans. In order to assess the likelihood of potential default of a loan (i.e. the associated risk of granting credit), the lender or credit grantor will obtain financial information regarding the prospective borrower. This data is typically provided by the borrower as well as third party credit bureaus. The foregoing financial information can include the borrower's (i) current income; (ii) value of assets; and (iii) past loan or credit payment history. The financial information allows creditors and lenders to assess the likelihood the borrower will make timely payments of principal and interest if credit terms are granted. As such, lenders and credit grantors commonly utilize risk-based pricing matrices wherein the perceived risk of nonpayment by the borrower (i.e. the risk of default of the loan obligation) is mitigated by (a) applying higher rates of interest and/or loan servicing fees; or (b) declining to extend credit on any terms, altogether.

However, mere risk-based pricing is sometimes insufficient protection from loan defaults, particularly with loans involving substantial sums. Lenders and creditors cannot afford to simply “charge-off” larger loans as a result of default on the part of the borrower. To do so might have a significant negative impact on the lenders cash flow and may as a practical matter threaten the lender's own business as a going concern. To allow for recovery, lenders and creditors often hold the borrower's property as collateral. The foregoing is known as a security interest. In the event of the borrower's default, the lender or creditor can take possession of and liquidate the collateral and use the liquidation proceeds to repay the balance of the loan.

A common security interest taken by the lender or creditor is in the subject of the transaction that is being financed. Common consumer examples can include houses and automobiles. However, where the subject of the financed transaction is not property, retaining a security interest vis-à-vis the financed transaction is not possible and retaining a security interest vis-à-vis an alternative form of legitimate collateral is typically not practical. The foregoing often arises in the rendition of professional services, such as medical and dental care, legal counsel, accounting and investment advice. Accordingly, financing of professional services is often on an unsecured basis.

Due to the high cost of many professional services and inability to retain security interests, lending institutions are often unwilling to extend credit to the customers of professional service providers. Because many professional service providers fail to generate the minimum charge activity required by major national credit card companies, such as VISA and Master Card, they are unable to allow their clients to finance services with the client's existing revolving credit limits. As a result, to avoid losing business, the professional service providers often provide professional services on an unsecured credit basis to their clients. Rendition of professional services to clients on an unsecured credit basis carries a considerably higher risk of nonpayment for services provided especially in those cases where the professional service provider is unable to assess the credit worthiness of the client. The foregoing is a common risk taken by the professional service provider community inasmuch as they lack the requisite skills and access to information necessary to determine risk of nonpayment (i.e. unlike traditional lenders, professional service providers typically do not underwrite the risk of nonpayment by requesting information about the client's income, assets, or previous credit history). Furthermore, unlike banks and other traditional lenders, professional service providers are not members of national credit reporting entities and as such are unable to report client payment history (timely, delinquent or nonpayment) to credit bureaus. As a result of the unsecured nature of professional service provider payment obligations and the inability of the service provider to attempt to bring accounts current by reporting delinquencies to credit bureaus, many unpaid accounts are simply written off. Delinquent accounts and outright charge-offs of account receivables are a major problem affecting the revenue and profitability for professional service providers.

Accordingly, it would be advantageous to increase collection of accounts for vendors of goods and services.

### SUMMARY

This disclosure relates to a method and system for managing traditional accounts receivable, which are generated in the normal course of business when any vendor sells any product or renders any service to a customer or consumer who is unable to make a full payment for the product or service, or its equivalent, at the time the sale. One embodiment of the disclosed system is a system for improving the likelihood of collection of account receivables for professional services. The system, however, is not limited to the field of service providers, but may also be used for vendors or merchants that sell goods or products. The likelihood of payment by a client for services rendered is enhanced by the origination of a loan by a traditional bank lender. According to one aspect of the invention, the loan may be arranged, and subsequently serviced, by a third party loan servicing company. In another embodiment, the loan may be originated and arranged directly by a representative of the bank. In general, the process is initiated when the client chooses a qualified service provider. The client and the qualified service provider agree on the scope of the service to be provided as well as the cost of the service and the terms by which the client will compensate the qualified service provider. With the assistance of the qualified service provider, the client completes a loan application, which is submitted to the loan servicing company. The loan servicing company compiles all necessary data required to underwrite the loan including, among other things (i) the client's current income; (ii) the value of the client's assets and liabilities; (iii) employment history; (iv) credit payment history; and (v) all other data as required by the bank to determine whether credit will be granted and, if so, under what terms. The loan servicing company maintains relationships with traditional lenders and chooses one or more that might be likely to approve the request for a loan. If the bank approves the loan, then the client executes a note in favor of the lender, who also has on obligation to forward a portion of the payments to service provider. On behalf of the bank, the loan servicing company proceeds to collect on the loan from the client. As and if the bank collects on the loan, the bank releases the pledged proceeds back to the qualified service provider less (i) the contractually agreed upon interest due the lending institution; and (ii) the agreed upon loan servicing fee due the loan servicing company.

The service provider may assign its right to collect the balance of the fee owed by its client to the bank simultaneously with the client executing a loan obligation with the bank, with the identical intended result of the bank releasing the loan payment proceeds to the qualified service provider less (i) the contractually agreed upon interest due the lending institution and (ii) the agreed upon loan servicing fee due the loan service company. The client may also endorse the proceeds to the qualified service provider who in turn pledges the proceeds back to the originating bank as collateral.

The foregoing system can be implemented electronically using the Internet as a communication medium. The loan servicing company's services can be established as a Web-site accessible from a personal computer by the client and the qualified service provider. The loan application and loan documents may be transferred over the Internet. Evaluation of the loan application and other sources of information required to underwrite the loan can be by means of software installed at the loan servicing company's and lending institution's Web-sites.

### BRIEF DESCRIPTION OF THE DRAWINGS

FIG. 1 is a block diagram depicting a three-party loan servicing system;

FIG. 2 is block diagram depicting a four-party loan servicing system;

FIG. 3 is a block diagram depicting another four-party loan servicing system and their relationships and transactions;

FIGS. 4(a) through 4(e) are flow-chart diagrams depicting the process flow associated with one aspect of the invention;

FIG. 5 is a block diagram depicting one aspect of the invention utilizing a computer network; and

FIG. 6 is a block diagram depicting another aspect of the invention utilizing a computer network.

### DETAILED DESCRIPTION

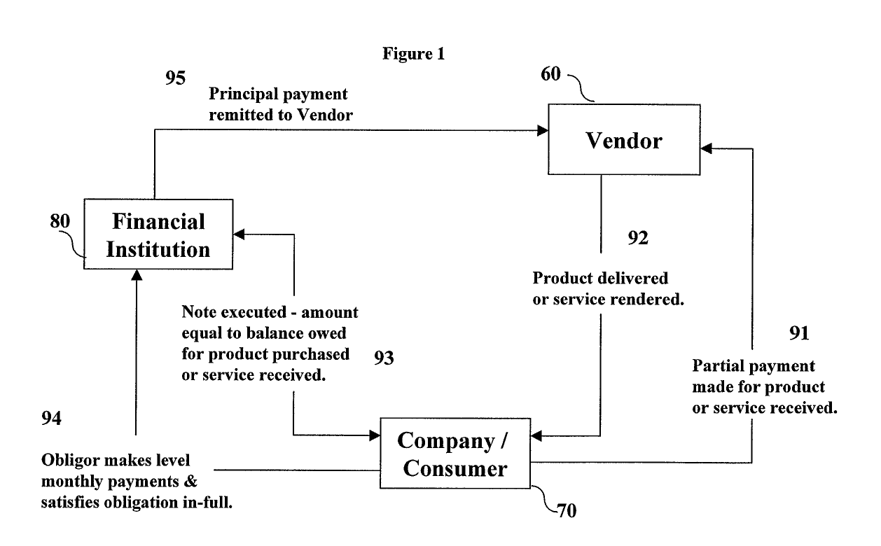

FIG. 1 depicts one aspect of the invention in which three parties execute a financial transaction. As depicted in FIG. 1, the system may be utilized in connection with the sale of any product or service 92 by a vendor 60 to a customer or consumer 70, which may be a business or an individual. Rather than creating a traditional accounts receivable arrangement between the vendor 60 and the customer or consumer 70, the system allows a customer or consumer 70 to make a partial payment 91 directly to the vendor 60 and execute an installment purchase note 93 with a financial institution 80. The system may also be used where the entire transaction amount is financed and no partial payment 91 is provided to the vendor 60. The financial institution 80 may be a traditional, insured depository institution (i.e. a bank, savings & loan, thrift, etc.) or a non-bank, uninsured, licensed finance company. If the customer/consumer 70 is approved for financing by the lending institution 80, a note is forwarded to the customer/consumer 70 for execution. After the note is executed by the customer/consumer 70, the vendor 60 is not required to maintain a traditional accounts receivable system evidencing the customer/consumer's 70 remaining financial obligation, (i.e. a lump sum owed, terms 30-days net, etc.). Traditional accounts receivable are customarily difficult to collect and represent an unpredictable and unreliable source of future cash flow to the vendor 60. The disclosed system and method therefore eliminates the payment obligation that the customer/consumer 70 has to the vendor 60. Instead, the customer/consumer 70 has a financial obligation owed to the financial institution 80 as evidenced by the execution of the note 93.

According to one embodiment, the note will have a fixed interest rate, stated term to maturity, and obligate the customer/consumer 70 to make a fixed monthly payment to the financial institution 80. According to another aspect, a note will be originated in connection with each discrete transaction 92 between a vendor 60 and the customer/consumer 70. Yet another aspect teaches that the note does not cross-collateralize the obligation of a customer/consumer 70 in connection with the receipt of multiple products or services from (i) any one vendor 60; or (ii) a plurality of vendors 60. As the customer/consumer 70 makes the monthly payment 94 to the financial institution 80, the financial institution 80 will typically retain the interest and remit the principal 95 to the vendor 60. Because the customer/consumer 70 has entered into a traditional loan arrangement 93 with the financial institution 80, the likelihood of timely payment on the part of the customer/consumer 70 is significantly increased. This is because the note executed by the customer/consumer 70 constitutes a legal obligation to a credit reporting entity with sophisticated resources geared to the management and servicing of financial instruments. As a result, the vendor 60 realizes greater predictability and reliability with regard to future cash flow 95. And in the event of non-payment by the customer/consumer 70, recovery of the defaulted principal amount owed is subject to remedies not typically associated with collecting past-due accounts receivable; for example, potential garnishment of wages, monetary judgments, and/or attachment of liens to personal property.

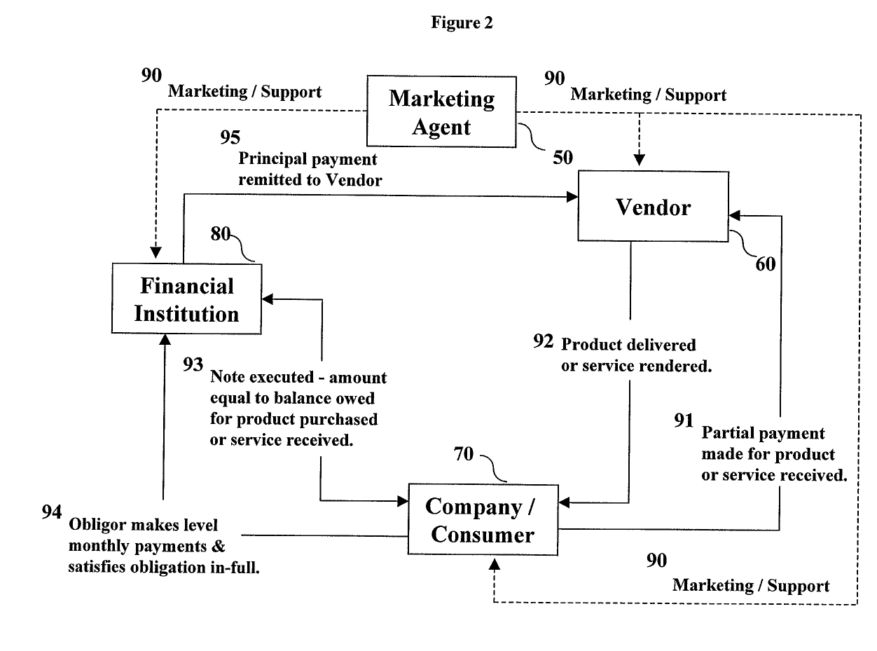

The disclosed system may be utilized in connection with (i) a discrete relationship between a single financial institution 80 and vendor 60; (ii) a discrete relationship between a single financial institution 80 and a plurality of vendors 60; (iii) a discrete relationship between a plurality of financial institutions 80 and a single vendor 60; or (iv) a discrete relationship between a plurality of financial institutions 80 and a plurality of vendors 60. Furthermore, as depicted in FIG. 2, the disclosed system may be facilitated by a third-party marketing agent 50 responsible for developing, supporting and maintaining relationships among a vendor 60 and a financial institution 80 or a plurality of vendors 60 and financial institutions 80.

The system may also be utilized in connection with the conversion of existing accounts receivables, which were created with respect to transactions previously consummated between a vendor 60 and its customer/consumer 70. Inasmuch as the system replaces a traditional account receivable with a note, and in consideration of the principal of the loan being remitted 95 to the vendor 60 as the customer/consumer 70 makes payment, it may or may not be beneficial or necessary to actually underwrite the creditworthiness of the customer/consumer 70 prior to the consummation of the transaction and execution of the note 93. The financial institution 80 may in many cases not require a prior assessment of the customer/consumer's 70 prior credit history. However, information gathered as a result of conducting a credit analysis on the customer/consumer 70 may render pertinent data, which may have future value (i.e. information useful in the recovery effort of delinquent notes); as such, certain embodiments of the system may incorporate an underwriting function.

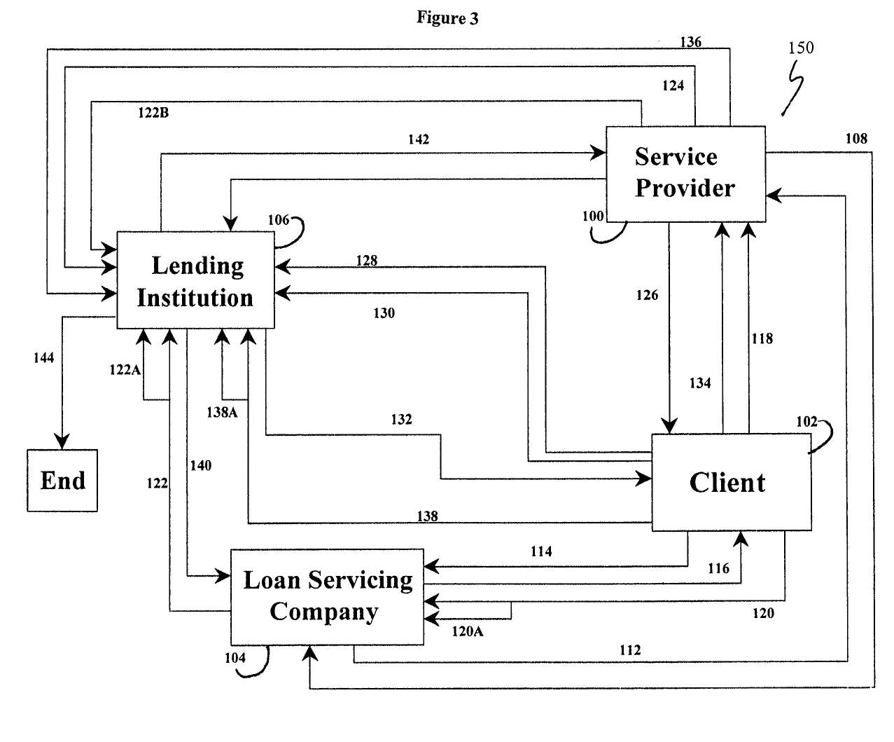

Referring now to FIG. 3, a block diagram of an exemplary loan servicing system, referred to generally by the numeric reference 150, is depicted for facilitating the delivery of services 126 from any one of a plurality of service providers 100 to a client 102. As noted above, many clients 102 are often unable to pay in full for the services 126 at the time the services 126 are rendered. Accordingly, the service provider 100 assists the client 102 in securing the requisite funding 132 in the form of a loan secured by a note 130, which is executed by the client 102.

The loan servicing company 104 is a business entity, which may receive and/or facilitate the submission of loan applications for credit 120 from the client. As previously described, this transaction may be executed without the loan servicing company 104. Prior to accepting application for credit 120 from the client 102, the client submits a notification 114 to the loan servicing company 104 seeking approval 116 as, or confirmation if already a customer of the loan servicing company, a client in good standing with the loan servicing company 104. Prior to receiving services 126 from a service provider 100, the service provider 100 may submit an application 108 to the loan servicing company 104 seeking approval 112 as, or confirmation if already one of the loan servicing company's 104 service providers 100, a qualified service provider.

Upon confirmation of good standing of the client 102 and the service provider 100, the client 102 has a consultation 118 with the service provider to discuss the nature of the desired services and reach agreement on the cost of services to be provided. If the client 102 and the service provider 100 come to terms, the client 102 submits an application for credit 120 to the loan servicing company 104 as proxy for the bank or lending institution 106 seeking funding in an amount equal to the total agreed upon cost of the services 126 to be provided less any amount paid prior to or immediately after delivery of the services 126. In certain instances, it should be appreciated, the loan servicing company 104 may direct the client 102, or simply pass on the application for credit 120 (or other submission) directly to a lending institution 106.

The loan servicing company 104 evaluates the notification 114 and facilitates submission of the application for credit 120A to any one of a plurality of lending institutions 106. Upon receipt of the application for credit 120, the loan servicing company 104 files the application for credit 122 with any one of a plurality of banks or lending institutions 106 (now referred to as a lending institution). Evaluation of the application for credit by the lending institution 122A can include a review of information contained in the application for credit 122 as well as a review of information obtained from other sources, such as credit bureaus. The loan servicing company 104 can file the application for credit 122 along with information obtained from other sources with a predetermined lending institution 106 or select the lending institution 106 from a plurality of lending institutions. Wherein the loan servicing company 104 selects the lending institution 106 from a plurality of lending institutions 106, the selection can be based on a number of criteria. For example, the lending institution 106 can be based upon the credit-worthiness of the client 102, wherein applications for “prime” credit-worthy clients 102 are forwarded to a lending institution 106 that serves the “prime” credit-worthy client market, and wherein applications for “non-prime” credit 122 are forwarded to a lending institution that serves the “non-prime” credit-worthy client market.

The selected lending institution 106 decides whether to approve or deny the application for credit 122. If the lending institution denies the application for credit, the client for whom the services 126 are to be provided may secure a guarantee 122B from the service provider 100 in order to satisfy the underwriting criteria of the lending institution 106. Upon approval of the application for credit 122A, the service provider 100 forwards an executed affirmation agreement 124 to the lending institution 106 affirming the service provider's 100 obligation to pledge 136 an endorsed client check 134 back to the lending institution upon receipt of the endorsed check 134 from the client 102. In an alternative embodiment, an endorsed check 134 is not used and the parties will be bound by their respective notes, pledges, and guarantees. Upon receipt of the affirmation agreement 124, the service provider provides the agreed upon service 126 to the client 102. The affirmation agreement 124 may not be required in instances where, for example, the service provider has agreed to assign its right to collect the balance of the fee owed by the client 102 to the bank simultaneously with the client 102 executing a loan obligation with the lending institution 106 in which case the loan payment proceeds made by the client 102 to the lending institution 106 are released back to the qualified service provider when made less (i) the contractually agreed upon interest due the lending institution 106; and (ii) the agreed upon loan servicing fee due the loan service company 104. Other suitable arrangements may be utilized depending upon the lending institutions' requirements, the credit-worthiness of the client, or other factors.

Once the service provider 100 completes the service 126, the client 102 provides notification 128, which may be in the form of an executed completion certificate, to the lending institution 106 that the service 126 has been provided in a full and satisfactory manner. Upon receipt of the notification of satisfactory completion of service 128, the lending institution 106 forwards the proceeds 132 to the client 102 in exchange for a promissory note 130 from the client 102. The proceeds 132 that are disbursed by the lending institution 106 may be in the form of a negotiable instrument 132 payable to both the client 102 and the service provider 100. If so, then the client 102 is required to immediately pledge 134 the negotiable instrument 132 to the service provider 100. The service provider 100 would then be required to pledge 136 the negotiable instrument 132 back to the lending institution 106 pursuant to the preexisting affirmation agreement 124. Or, in a similar manner, upon receipt of the notification of satisfactory completion of service 128, the service provider simply agrees to assign its right to collect the balance of the fee owed by its client to the bank simultaneously with the client executing a loan obligation with the lending institution 106 requiring loan payment proceeds made by the client 102 to the lending institution 106 to be released back to the qualified service provider when made less (i) the contractually agreed upon interest due the lending institution 106; and (ii) the agreed upon loan servicing fee due the loan service company 104.

After the notes, pledges and guarantees have been executed, the client is then required to make contractual payment 138 of principal and interest to the lending institution 106 pursuant to the terms and conditions of the promissory note 130. As the customer forwards payments 138 to the lending institution 106, the lending institution retains the interest portion of the payment 138A. The lending institution 106 then forwards the contractual service fee 140 to the loan servicing company 104 and the net proceeds are then disbursed 142 to the service provider 100. The process requiring the client 102 to forward payment 138 to the lending institution 106 who in turn retains the interest portion 138A of the payment 138 and subsequently forwards the servicing fee 140 to the loan servicing company 104 with the net proceeds being forwarded 142 to the service provider 100, is repeated until such time as the client 102 has satisfied its obligation pursuant to the promissory note 130, at which time the process is completed 144.

In the foregoing manner, services 126 are provided to the client 102 by the service provider 100. Payment for service 126 is handled by collection on the promissory note 130 by the lending institution 106. Because of the lending institution's 106 expertise in (a) underwriting credit; (b) collecting timely payment of principal and interest; and (c) reporting to credit bureaus the actual payment behavior of the client 102, the risk of non-payment by the client 102 is considerably reduced. In any event, the risk of non-payment is bore by the service provider 100 inasmuch as the loan proceeds are ultimately and only released 142 to the service provider 100 if and when a payment 138 is received by the lending institution 106 from the client 102.

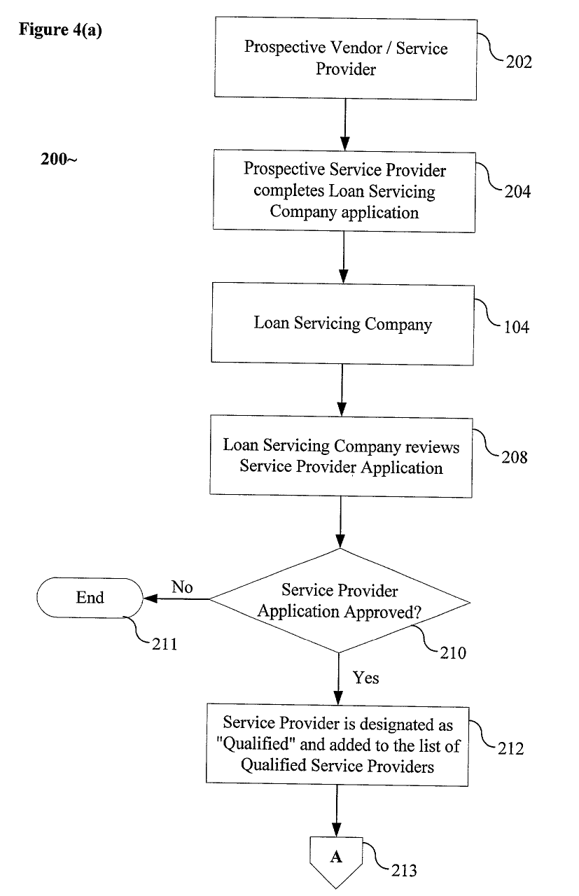

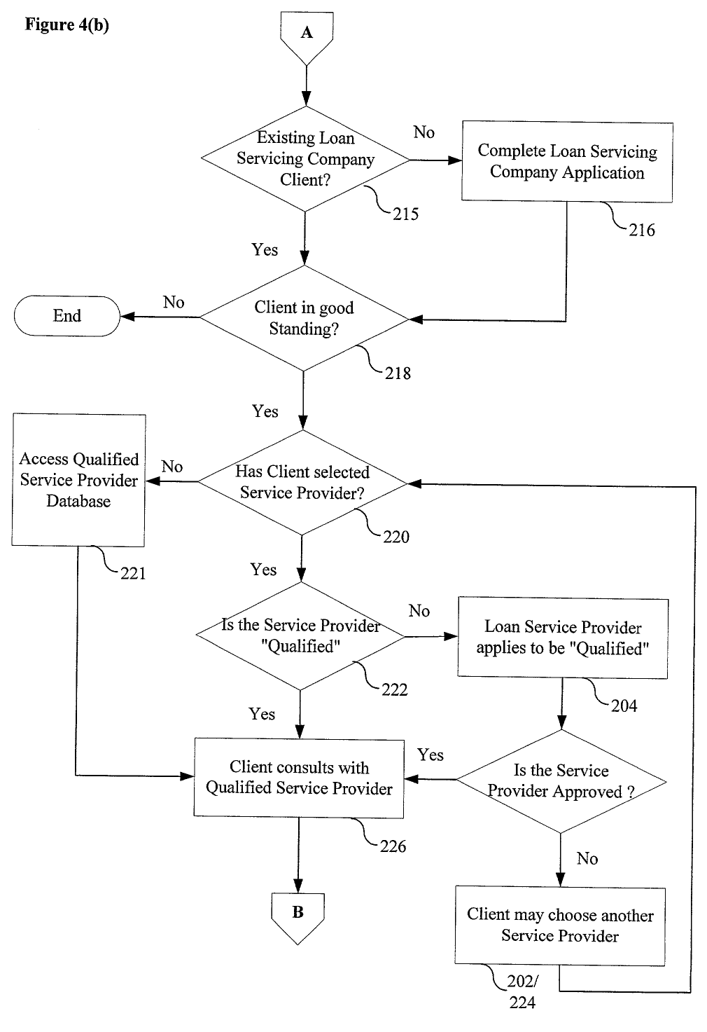

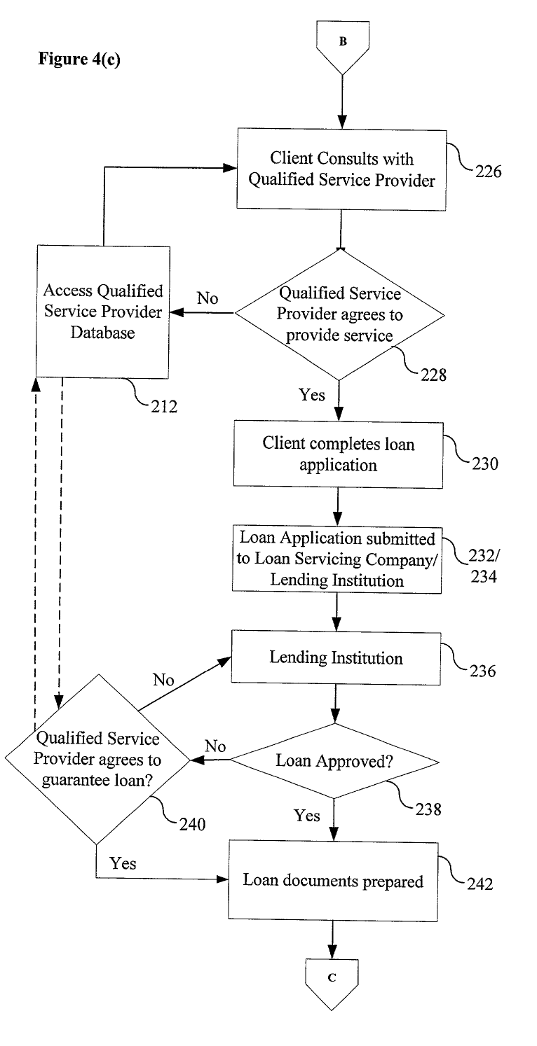

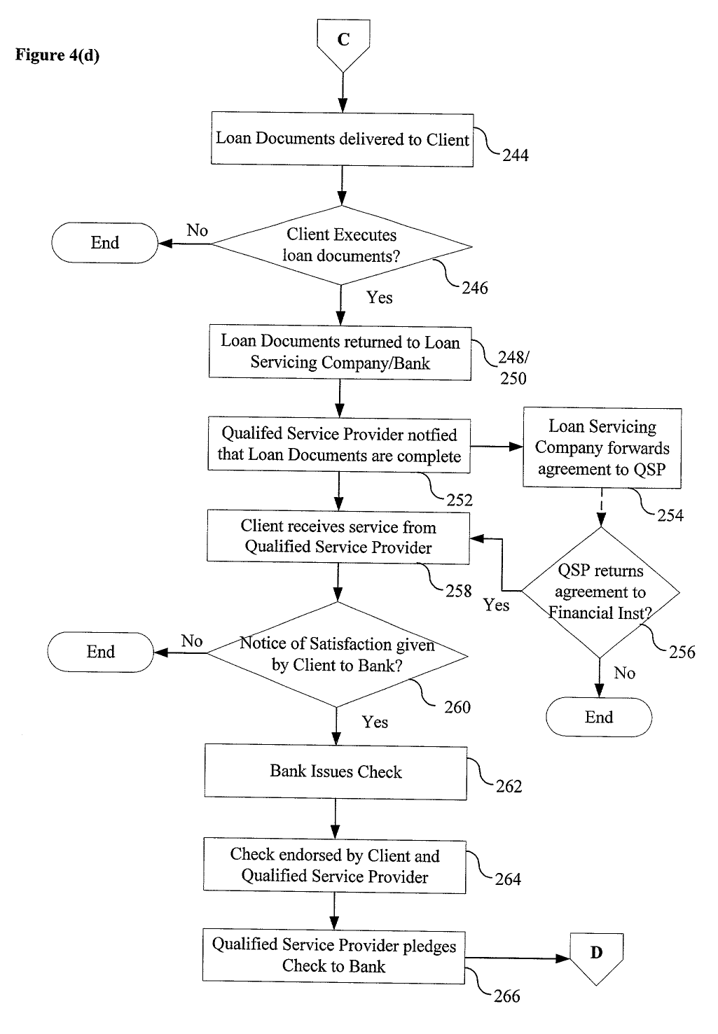

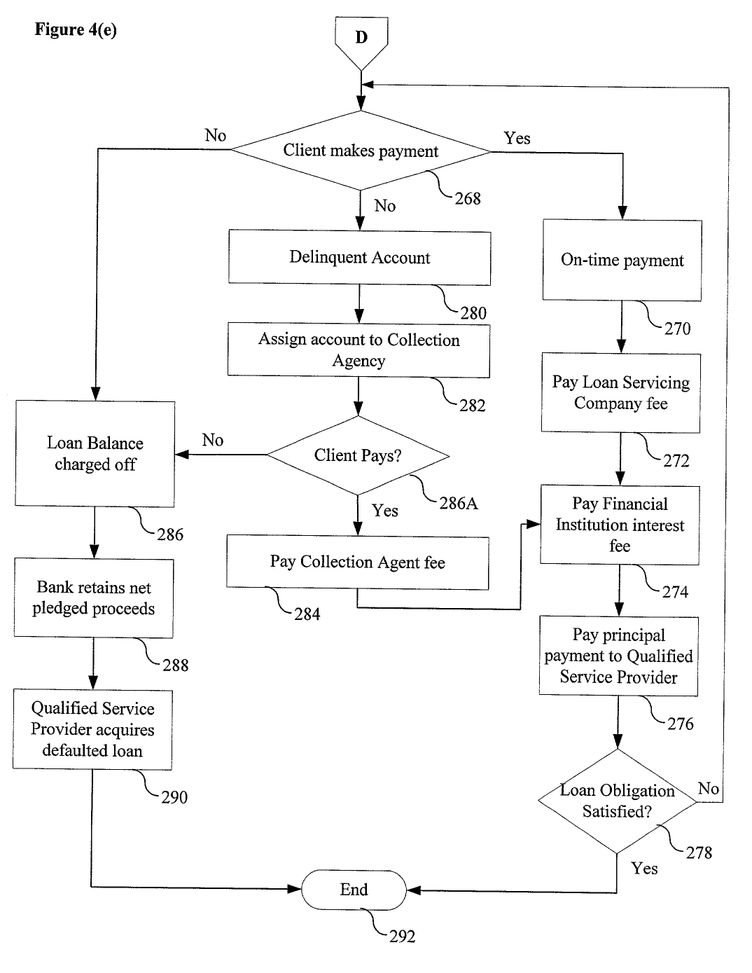

Referring now to FIGS. 4(a)-4(e), depicted therein is a process flow diagram of an exemplary loan servicing system, referred to generally by the numeric reference 200, for facilitating the delivery of services 126 from any one of a plurality of qualified service providers 100 to a client in good standing 102 with the loan servicing company.

As noted above, many clients are often unable to pay in full for the services at the time the services are rendered. Accordingly, the qualified service provider might assist a client in good standing in preparing an application for credit and submitting it to the loan servicing company. Prior to having access to the services provided by the loan servicing company, a prospective service provider 202 may be required to submit an application 204 and an application fee to the loan servicing company in order to attain active status as a qualified service provider. Accordingly, if the client is not a prior customer of the loan servicing company, then the client may be required to submit an application and an application fee in order to attain active and in-good standing status with the loan servicing company.

Referring to FIG. 4(a), a prospective service provider 202 may be required to submit a loan servicing company application 204 to the loan servicing company 104 requesting admission to the loan servicing company's database of approved qualified service providers. The loan servicing company will review the application 208 and determine if the service provider 202 meets its criteria for participation in the program 210. If the application is approved by the loan servicing company 104, then the vendor/service provider 202 is added to the list of qualified service providers 212. If the application is not approved, then the vendor/service provider 202 is not added 211. The application for membership can include financial information about the service provider such as its bank accounts, credit history, debt load, etc.

Referring now to FIG. 4(b), any customer seeking to finance the purchase of services from a qualified service provider may also be required to complete an application with the loan servicing company. Prior to receiving services, a test may be performed to determine if the customer is an existing client of the loan servicing company 215. If the customer is not an existing client, then he/she may be required to submit an application to the loan servicing company 216. The application for membership can include financial information about the customer such as his bank accounts, credit history, debt load, or any other information necessary to secure a credit report. Membership may also be granted on a pro-forma basis wherein the application is merely used to collect statistical and demographic information about the applicant, such as age, income level, marital status, etc. If the customer is an existing client of the loan servicing company, then another query may determine if he is a client in good standing 218. This inquiry can be based upon payment history, credit rating, or other information. If the client is in good standing 218 and is seeking professional services from a prospective service provider 202 that is not associated with the loan servicing company 104, then this service provider 100 must then satisfy the loan servicing company's requirements for eligibility, such as by executing a loan servicing company application 204. If, on the other hand, the client in good standing does not have a service provider, or, if the client in good standing's service provider 100 fails to satisfy the requirements to become a qualified service provider, then the client may select a qualified service provider from the loan servicing company's database of qualified service providers 221. Once the client in good standing identifies a qualified service provider, the client in good standing may consult with the qualified service provider regarding the desired services 226.

Referring now to FIG. 4(c), the client in good standing consults with the qualified service provider to determine the service to be rendered and the price for the services 226. If the qualified service provider agrees to provide the desired services to the client in good standing 228, then the client in good standing should complete the required loan application documents 230. Should the qualified service provider decline to provide the desired services to the client in good standing, then client in good standing may select an alternative qualified service provider from the loan servicing company's database of qualified service providers 212. After selecting another qualified service provider, the consultation process with that qualified service provider is resumed 226. Once a qualified service provider agrees to provide services to the client in good standing 228 and the loan application documents are completed 230, the loan agreement is then submitted to the loan servicing company for evaluation 232. In an alternative embodiment, the loan application documents are submitted directly to the lending institution. Upon receiving and evaluating the application for credit, the loan servicing company submits the application to one or more lending institutions 236. Evaluation of the application for credit by the lending institution 236 can include a review of information contained in the application for credit as well as a review of information obtained from other sources, such a credit reporting bureaus.

The loan servicing company can submit the loan application, along with information obtained from the other sources, with a predetermined lending institution or select the lending institution from a plurality of lending institutions. Wherein the loan servicing company selects the lending institution from a plurality of lending institutions, the selection can be based on a number of criteria. For example, the lending institution can be selected based on the determined credit-worthiness of the client in good standing, wherein applications for credit-worthy clients in good standing are forwarded to a lending institution that serves the “prime” credit-worthy borrower market, and wherein applications for noncredit-worthy clients in good standing are forwarded to a lending institution that serves the “non-prime” credit-worthy borrower market.

The selected lending institution 236 decides whether to approve or deny the application for credit in accordance with its established loan underwriting criteria 238. If the lending institution approves the loan application for credit 242, the requisite loan documentation and promissory note (now referred to as the loan documents), are prepared and delivered to the client in good standing 244. If, on the other hand, the lending institution 236 declines to approve the loan application, the client in good standing may request that the qualified service provider guarantee the loan on the client's behalf 240. Should the qualified service provider decline to provide a guarantee of the loan 240 to the lending institution, then (a) the loan application may be submitted to an alternative lending institution 236; and/or (b) the client in good standing may select an alternative qualified service provider 212, who is willing to guarantee the loan 240.

Referring now to FIG. 4(d), once the client in good standing has been approved for a loan, then the loan documents are delivered to the client in good standing 244. After the client in good standing executes the loan documents 246, the client in good standing returns the fully executed loan documents to the loan servicing company 248 and/or the lending institution 250. If the documents are returned to the loan servicing company, then it may review the loan documents to confirm they have been fully and accurately completed. Once satisfied that the executed loan documents are complete, the loan servicing company forwards them to the appropriate lending institution 250. Upon receipt of the executed loan documents, the lending institution provides a notification to the qualified service provider 252 and forwards the agreement to the qualified service provider 254. After executing the agreement, the qualified service provider returns the agreement to the lending institution 256. At this point, the service provider is free to render the services to the client in good standing.

Subsequent to providing the agreed upon services by the qualified service provider to the client in good standing, the client in good standing provides written notice of satisfaction of completed services to the lending institution 260. This notification may be passed through the loan servicing provider. Depending upon the specific embodiment, the lending institution then issues a negotiable instrument 262 made payable to the client in good standing and to the qualified service provider. Next, the client in good standing and the qualified service provider both endorse the negotiable instrument 264. Once endorsed by both parties, the negotiable instrument is immediately pledged by the qualified service provider back to the originating lending institution pursuant to the preexisting contractual agreement between the qualified service provider and the lending institution 266. In certain instances, instead of issuing a negotiable instrument made payable to the client in good standing 102 and the qualified service provider 100, the qualified service provider will simply agree to assign its right to collect the balance of the fee owed by its client in good standing to the lending institution simultaneously with the client in good standing executing the loan documents. According to this embodiment, the lending institution agrees to release the loan payment proceeds made by the client in good standing back to the qualified service provider less (i) the contractually agreed upon interest due the lending institution; and (ii) the agreed upon loan servicing fee due the service company.

With reference to FIG. 4(e), after the negotiable instrument has been pledged to the lending institution 266, the client in good standing forwards the contractual principal and interest payments to the lending institution 268. If the client in good standing makes timely payment of the contractual principal and interest payments 270, then the lending institution (a) credits the account of the loan servicing company in an amount equal to its contractual service fee 272; (b) credits its own account in an amount equal to the contractual interest rate 274; and (c) forwards the net remaining proceeds to the qualified service provider 276. Steps 268 through 276 are repeated until the client in good standing satisfies the loan obligation 278 or defaults on the loan leaving no further remedy other than to charge-off the loan 286. After the client in good standing satisfies the loan obligation in 278, the process is terminated 292.

Should the client in good standing become delinquent in making payments 280, the loan servicing company may elect to assign the loan to a collection agency for recovery of delinquent payments 282. Should the collection agency succeed in recovering delinquent payments 286A from the client in good standing, then (a) the collection agency is entitled to retain an amount equal to its contractual service fee 284 and forwards the net proceeds to the lending institution; at which time (b) the lending institution credits its own account in an amount equal to the contractual interest rate 274; and then (c) forwards the net remaining proceeds 276 to the qualified service provider. Steps 268 through 276 are then repeated until the client in good standing satisfies the loan obligation 278 or defaults on the loan leaving no further remedy other than to charge-off the loan 286. Wherein the client in good standing 218 satisfies the loan obligation in 278, the process is terminated 292.

Should the client in good standing fail to make payment and if the loan is subsequently deemed non-collectible, the remaining loan balance is charged-off by the lending institution 286. If the client in good standing ultimately defaults necessitating the lending institution to charge-off the loan 286, then (a) the lending institution takes possession of the remaining loan proceeds 288; (b) the qualified service provider is then entitled to acquire the defaulted note from the lending institution along with all related loan documents 290; and (c) the process is terminated 292.

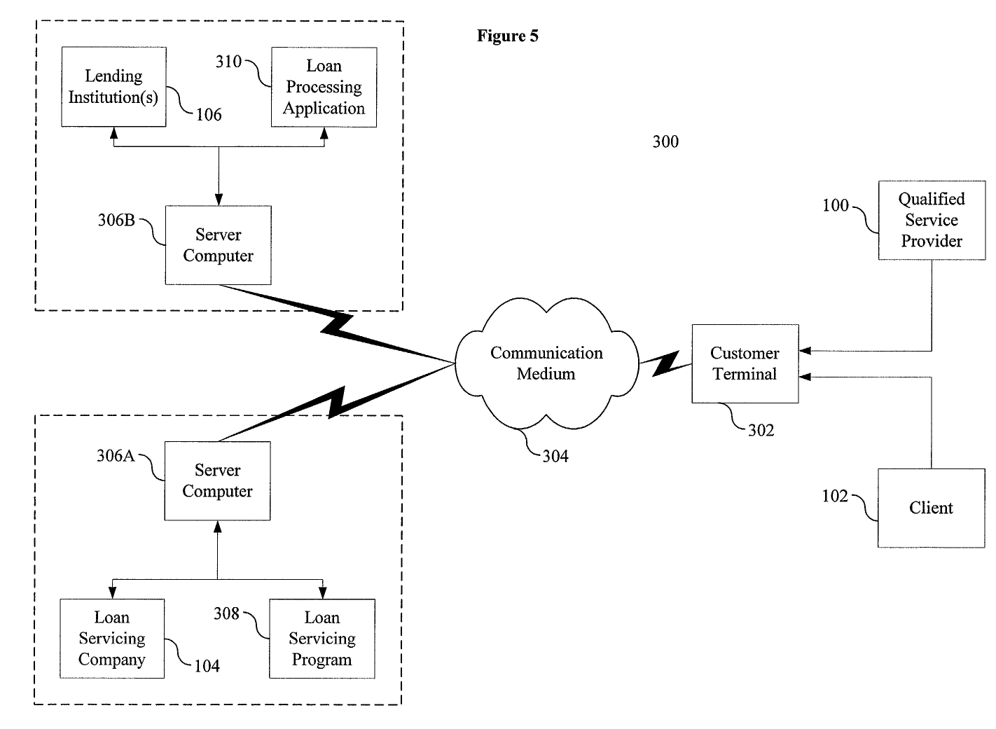

Referring now to FIG. 5, there is illustrated a block diagram of a computer network, referenced generally by the numeric designation 300, for facilitating the delivery of services by qualified service providers 100 to clients 102. The computer network 300 includes two or more server computers 306 associated with any number of customer terminals 302. The server computers 306 and the customer terminals 302 are interconnected by a communication medium 304, which can include, for example, the Internet, a connection within the public switched telephone network, a wireless connection, a local area network (LAN) connection, or an Ethernet connection, or any combination thereof. Additionally, access to a particular server computer 306 can be facilitated by means of a web page and a predetermined web address associated with the server computer 306, wherein the web page appears at the customer terminal 302 responsive to entry of the web address into a web browser.

The loan servicing company 104 and each lending institution 106, can be associated with a particular one of the server computers 306A, and 306B, respectively. The customer terminal 302 can be associated with a qualified service provider 100. The completion of the application for credit 230 can be facilitated by a graphical user interface displayed at the customer terminal 302 which prompts the client 102 to provide information, such as financial information and credit information. The foregoing information is received by the server computer 306A associated with the service company 104. The server computer 306A associated with the service company 104 can have a loan servicing program 308 which evaluates the information received from the customer terminal 302 as well as from other sources, and forwards the foregoing to the selected lending institution 106. Additionally, the loan servicing program 308 can include logic for selection of a particular lending institution from a plurality of lending institutions based on the evaluation.

The server computer 306B associated with the lending institution can also be equipped with a loan processing application 310 which receives the information from the server computer 306A associated with the loan servicing company 104. The loan processing application 310 can also include logic for determining whether to approve or deny the loan. Additionally, the server computer 306B associated with the lending institution 106 can be equipped with accounts receivable software for tracking the repayment of the loan by the client 102.

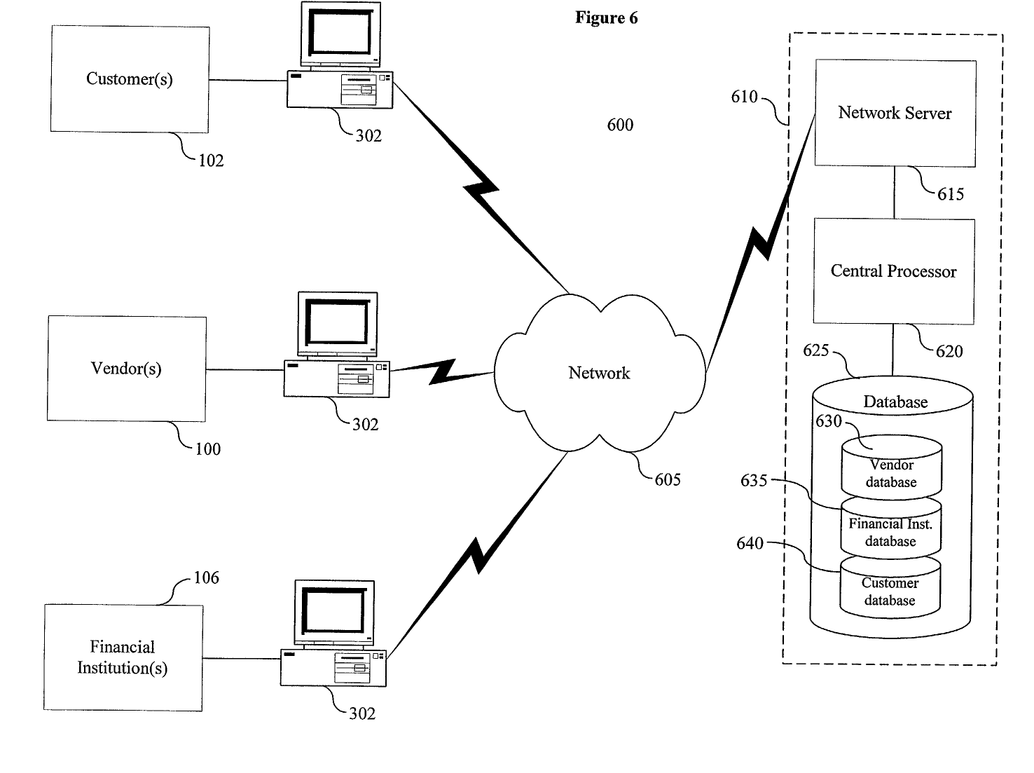

Another exemplary embodiment of the invention is depicted in FIG. 6. This embodiment is referred generally by the reference numeral 600. In FIG. 6, a customer/client 102 uses a terminal 302 to access a computer network 605, which may be the Internet. In addition, a vendor/service provider 100 and a financial institution 106 can use similar terminals 302 to access the computer network 605. Also connected to the computer network is a loan servicing system 610, which comprises a network server 615, a central processor 620, and a database 625. The network server 615 is used to maintain the loan servicing system's 610 presence on the computer network 605. The network server 615 may therefore be embodied in a router or other suitable communications device. The central processor 620 comprises a computer processor and memory encoded with instructions for controlling the computer processor. The computer processor may be embodied in the form of many commercially available mainframe, server, or desktop computers. The memory encoded with instructions may be embodied in the form of computer software adapted for execution on the computer processor. The database 625 may be embodied in the form of a commercially available database product. According to one embodiment, the database 625 comprises three databases: a vendor database 630; a financial institution database 635; and a customer database 640. The vendor database stores information about qualified vendors or service providers that are participants in the financing system. The vendor database 630 also includes searchable information about the goods and services provided by each vendor/service provider. According to one aspect of the invention, information is stored in the vendor database 630 in a format that is searchable by using the Structured Query Language (SQL). The financial institution database 635 stores information about the financial institutions that have elected to participate in the financing system. The financial institution database 635 also includes searchable information about the credit qualifications and underwriting standards for each financial institution. According to one aspect of the invention, information is stored in the financial institution database 635 in a format that is searchable by SQL. The customer database 640 comprises a variety of information about the customers/clients that are participants in the financing system. Statistical and demographic information about each customer may be stored therein so that statistical analysis and data-mining can be conducted. Furthermore, the customer database 640 may be used to store real-time information about the amount of the outstanding balance owed by each customer to a specific vendor/service provider. This information may be accessed by the client, the vendor, and the financial institution at any time, depending upon the level of access granted to that entity. According to another aspect of the invention, the data regarding the outstanding balance amount may be retrieved and viewed by any of the customer, the vendor, or the financial institution by using an Internet browser program at their respective computer terminals 302. Another aspect of the invention contemplates that a customer 102 may use the computer terminal 302 to conduct searches of the vendor database 630 to identify a participating vendor 100 that provides a certain good or service. Such a search may yield more than one vendor 100 so that the customer can select from a plurality of participating vendors 100. Furthermore, the loan servicing company 104 may utilize the system 600 to search the financial institution database 635 for a financial institution 106 that has appropriate lending practices to suit a customer 102 with certain financial or credit background information. In addition, the customer 100 may be able to download, complete and upload a loan application electronically by using the terminal 302. In this manner, many of the operations of the loan servicing company can by automated through use of the loan servicing system 610, therefore reducing paperwork and improving the efficiency of its operations.

While certain embodiments of the present invention are described herein with particularity, those having normal skill in the art will recognize various changes, modifications, additions, and applications other than those specifically mentioned herein without departing from the spirit of this invention.

The following is claimed:

1. A method for financing a transaction between a vendor and a customer comprising:
providing a vendor database describing a plurality of vendors and the goods and services offered by each respective vendor;
receiving an application for a loan from the customer to finance a transaction between the customer and a vendor listed in the vendor database;
if the customer satisfies a first set of criteria, then performing the following steps a) through d):
a) approving the grant of a loan to the customer;
b) providing a note to the customer, the note describing a principal amount to be financed, an amount of interest to be assessed, and a term of the note;
c) receiving the executed note from the customer;
d) performing steps e) through g) until the full amount of the note has been paid;
e) receiving a payment from the customer, the payment comprising a principal amount and an interest amount;
f) depositing the principal amount in an account corresponding to the vendor; and
g) depositing the interest amount in an account corresponding to the financial institution.

2. A method according to claim 1, further comprising:
receiving a request from a customer for a list of vendors that provide a requested good or service;
retrieving a list of vendors that provide the requested goods or service from the vendor database; and
providing the requested list of vendors to the customer.

3. A method according to claim 1, whereien if the customer satisfies the first set of criteria then performing the following:
forwarding to the customer, a negotiable instrument payable in the principle amount of the note to order of the customer and the vendor; and
receiving the negotiable instrument from the vendor, wherein the negotiable instrument has been indorsed by the customer and the vendor.

4. A method according to claim 1, wherein the first set of criteria is a credit rating score based upon the financial records of a vendor.

5. A method according to claim 1, further comprising:
receiving an application from a vendor; and
adding the vendor to the vendor database if the vendor satisfies a second set of criteria.

6. A method according to claim 5, wherein the second set of criteria is a credit rating score based upon the financial records of the customer.

7. A method according to claim 1, wherein the transaction to be financed is the sale of a service from the vendor to the customer.

8. A method according to claim 7, wherein the obligation of the customer to pay the note does not arise until after the vendor has provided the purchased service.

9. A method according to claim 1, wherein the transaction to be financed is the sale of goods from the vendor to the customer.

10. A method according to claim 1, wherein the note is guaranteed by the vendor.

11. A method for facilitating financing of a transaction between a vendor and a customer comprising:
receiving an application for a loan from the customer;
forwarding the loan application to a financial institution;
receiving a loan approval and a note from the financial institution, the note describing a principal amount to be financed, an amount of interest to be assessed, a service charge to be assessed, and a term of the note;
forwarding the note to the customer for execution;
receiving the executed note from the customer;
forwarding the executed note to the financial institution;
notifying the vendor that the customer has executed the note; and
receiving a service charge payment from the financial institution after the customer has made a payment on the note to the financial institution.

12. A method according to claim 11, further comprising:
providing a vendor database comprising a plurality of vendors and the goods and services provided by each respective vendor;
receiving an application from a vendor; and
adding the vendor to the vendor database if the vendor satisfies a second set of criteria.

13. A method according to claim 12, wherein the second set of criteria is a credit rating score based upon the financial records of the vendor.

14. A method according to claim 12, further comprising:
receiving a request from a customer for a list of vendors that provide a requested good or service;
retrieving a list of vendors that provide the requested goods or service from the vendor database; and
providing the requested list of vendors to the customer.

15. A method according to claim 11, wherein the transaction to be financed is the sale of a service from the vendor to the customer.

16. A method according to claim 15, wherein the obligation of the customer to pay the note does not arise until after the vendor has provided the purchased service.

17. A method according to claim 11, wherein the transaction to be financed is the sale of goods from the vendor to the customer.

18. A method according to claim 11, wherein the note is guaranteed by the vendor.

19. A method for facilitating financing of a transaction between a vendor and a customer comprising:
providing a vendor database describing a plurality of vendors and the goods and services offered by each respective vendor;
providing a list of financial institutions that have agreed to provide financing under if certain respective criteria are met;
receiving a request from a customer for a list of vendors that provide a requested good or service;
retrieving a list of vendors that provide the requested goods or service from the vendor database; and
providing the requested list of vendors to the customer;
receiving an application for a loan from the customer, the application including financial information about the customer;
selecting a financial institution from the list of financial institutions based upon the financial information about the customer;
forwarding the loan application to the selected financial institution;
receiving a loan approval and a note from the selected financial institution, the note describing a principal amount to be financed, an amount of interest to be assessed, a service charge to be assessed, and a term of the note;
forwarding the note to the customer for execution;
receiving the executed note from the customer;
forwarding the executed note to the selected financial institution;
notifying the vendor that the customer has executed the note; and
receiving a service charge payment from the selected financial institution after the customer has made a payment on the note to the selected financial institution.

20. A method according to claim 19, further comprising:
receiving an application from a vendor; and
adding the vendor to the vendor database if the vendor satisfies a first set of criteria.

21. A method according to claim 20, wherein the fist set of criteria is a credit rating score based upon the financial records of the vendor.

22. A method according to claim 19, wherein the transaction to be financed is the sale of a service from the vendor to the customer.

23. A method according to claim 22, wherein the obligation of the customer to pay the note does not arise until after the vendor has provided the purchased service.

24. A method according to claim 19, wherein the transaction to be financed is the sale of goods from the vendor to the customer.

25. A method according to claim 19, wherein the note is guaranteed by the vendor.

26. A computerized system for facilitating financing of a transaction between a vendor and a customer, the system comprising:
a network server adapted for connection to a computer network;
a central processor comprising a computer processor and a computer memory encoded with instructions suitable for execution on the computer processor, wherein the central processor is electrically connected to the network server;
a database comprising a vendor database, and a financial institution database, wherein the database is electrically connected to the central processor;
wherein the instructions are adapted to command the processor to perform the following:
receive a request from a customer for a list of vendors that provide a requested good or service;
retrieve a list of vendors that provide the requested goods or service from the vendor database; and
provide the requested list of vendors to the customer;
provide an electronic loan application to the customer;
receive a completed electronic loan application from the customer, the electronic loan application including financial information about the customer;
select a financial institution from the financial institution database based upon the financial information about the customer;
forward the electronic loan application to the selected financial institution;
receive an electronic loan approval from the selected financial institution;
forward the electronic loan approval to the customer;
receive a first electronic notification from the selected financial institution, the first electronic notification describing a note executed by the customer;
provide a second electronic notification to the vendor indicating that the customer has executed the note;
create an entry in the customer database corresponding to the customer's loan, the entry comprising a customer account number and a balance amount;
receive a third electronic notification from the selected financial institution describing a payment amount received by the selected financial institution;
determine a revised balance corresponding to the customer's loan based upon the payment amount described in the third electronic notification; and
store the revised balance in the customer database.

27. A computerized system according to claim 26, wherein each of the electronic notifications comprises an e-mail message.

28. A computerized system according to claim 26, wherein the requested list of vendors and the electronic loan application are provided to the customer in a format readable by an Internet browser program.

29. A computerized system according to claim 26, wherein the instructions for commanding the processor to provide an electronic loan application to the customer and to receive a completed electronic loan application from the customer further include instructions to encrypt the electronic loan application.

30. A computerized system according to claim 26, wherein the database further comprises a customer database and the instructions are further adapted to command the processor to perform the following:
after receiving the first electronic notification, create an entry in the customer database corresponding to the customer's loan, the entry comprising a customer account number and a balance amount;
after receiving the third electronic notification, determine a revised balance corresponding to the customer's loan based upon the payment amount described in the third electronic notification; and
store the revised balance in the customer database.

31. A computerized system according to claim 30, wherein the instructions are further adapted to command the processor to perform the following:
receive an electronic request for a balance amount from the customer;
retrieve a balance amount from the customer database; and
provide the retrieved balance amount to the customer.

32. A computerized system according to claim 31, wherein the retrieved balance amount is provided to the customer in a format readable by an Internet browser program.
